(19) United States
(12) Patent Application Publication
(10) Pub. No.: US 2010/0072067 A1
(43) Pub. Date: Mar. 25, 2010

(54) Label-Free High Throughput Screening Method by Using Sers Spectroscopic Encoded Bead and Dielectrophoresis

(75) Inventors: Yoon-Sik Lee, Gyeonggi-do (KR); Yong-Kweon Kim, Seoul (KR); Dae-Hong Jeong, Seoul (KR); Jong-Ho Kim, Seoul (KR); Min-Soo Kim, Seoul (KR); Hee-Jeong Choi, Seoul (KR); Bong-Hyun Jun, Daegu (KR)

Correspondence Address: VENABLE LLP, P.O. BOX 34385, WASHINGTON, DC, 20043-9998, US

(73) Assignee: Seoul National Univeristy Industry Foundation, Seoul (KR)

(21) Appl. No.: 11/992,017

(22) PCT Filed: Sep. 15, 2006
(86) PCT No.: PCT/KR2006/003689

§ 371 Date: Mar. 12, 2009

(30) Foreign Application Priority Data
Sep. 15, 2005 (KR) 10-2005-0086275

(51) Int. Cl. G01N 27/26

(52) U.S. Cl. 204/643

(57) ABSTRACT

Provided is a method for screening a biological molecule rapidly and economically with high-throughput using microbeads encoded with silver nanoparticles and a chemical compound and dielectrophoresis. A biological screening method particularly utilizes microbeads encoded with silver nanoparticles and a specific chemical compound and dielectrophoresis. Since this screening method does not use a fluorescent material and a dying agent, which are typically used in the conventional screening method, it is non-toxic and economical. Also, this screening method allows simultaneous identification of many target materials. Accordingly, a leading compound can be screened within a short period of time, and thus, this screening method can be implemented as an economical and effective system for developing new pharmaceutical products.

### TECHNICAL FIELD

The present invention relates to a label-free high-throughput screening method for a biological molecule, and more particularly, to label-free high-throughput screening method allowing fast and economical screening of a biological molecule using dielectrophoresis and microbeads encoded with silver nanoparticles and a chemical compound.

### BACKGROUND ART

Combinational chemistry is a newly developed organic chemical technique receiving a great attention due to its advantages in effectively designing and synthesizing a physiological activation molecule and deriving a new material. With use of this combinational chemistry, more compounds can be synthesized based on various building blocks, and thus, it is highly probable to discover a leading compound that is industrially useful and important. Hence, combinational chemistry is being highlighted as one technology that allows discovering a new leading compound. As mentioned in an article by J. Khandurina and A. Guttman, Current Opinion in Chemical Biology, 2002, 6:359(b) and in another article by J. Bronwyn and T. Matt, TRENDS in Biotechnology, 2002, 20:167, developing a high-throughput screening method in combination of miniaturization and automation is often considered the most important technology after a structure of human genome is revealed.

A fluorescent material-based screening method, a microarray chip-based screening method, and an enzyme-linked immunosorbent assay (ELISA), and a currently introduced Raman spectroscopic encoded nanoparticle probe-based screening method are related to a technology of identifying and analyzing compounds or biological molecules.

The fluorescent material-based screening method has been typically practiced in relevant fields. For instance, the fluorescent material-based screening method includes a multiplexed bead-based assay, optic fiber microbead array, and a quantum dot encoded bead assay. The multiplexed bead-based assay, for instance, the Luminex system, is a multiplex analysis apparatus that can analyze about 100 types of biological materials at the same time in each well of a 96-well plate. The multiplex bead-based assay uses two laser detectors to transmit signals in real-time and can distinguish and quantify about 100 different color groups of polystyrene beads. Particularly, in the Luminex system, polystyrene-based microbeads each having a diameter of 5.6 m are used as a carrier and dyed with two colored fluorescent pigments having a wide range of concentration. The content of each fluorescent pigment functions as an identification code. Diameters and colors of the microbeads are measured using a red colored laser and an automatic power down (APD) sensor, a biding amount of a sample is measured using a green colored laser and a photomultiplier tube. However, this method may have several difficulties in encoding beads by adjusting the content of a fluorescent pigment, having a limited number of fluorescent pigments and incapable of adding the screened target materials together and analyzing the screened target materials using another apparatus. Also, according to this method, a secondary antibody encoded with a fluorescent material generally needs to be used, and thus, analysis may become complicated and related costs tend to increase.

As illustrated in FIG. 11, in the optic fiber microbead array, microbeads are encoded with a fluorescent material such as Cy5, 6-carboxy-tetramethyl-rhodamine (TAMRA), or fluorescein, and then added with various ligands that can identify a target material in each of the encoded beads. After the ligands react with the target material, optic fibers are used to detect the presence or absence of the target material. Details of this optic fiber microbead array method are provided in Animal Chemistry, 2000, 72:5618. However, this method may have limitations in that the number of fluorescent materials that can encode beads is restricted, and sensitivity decreases due to photo-bleaching of a fluorescent material.

Referring to FIG. 12, in the quantum dot encoded bead assay, quantum dots based on a semi-conductive material show a wide range of colors depending on the size of a quantum dot. Thus, the number of optical colors generated from this method is greater than that from the organic fluorescent methods, and more increasing numbers of the optical colors can be encoded as compared with the other methods. Microbeads are encoded with quantum dots having various colors. A specific ligand is fixated to the beads dyed in various colors and reacts with a target material encoded with an organic fluorescent material, thereby allowing screening of the target material. This quantum dot encoded bead assay method is explained in detail in Nature Biotechnology, 2001, 631. However, in this method, mass production of quantum dots is often difficult, and quantum dots are usually too expensive and toxic.

As described in an article by D. J. Lockhart and E. A. Winzeler, Nature, 2000, 405:827, another article by G. MacBeath, Genome Biology, 2001, 2:2005, another article by G. MacBeath and L. S. Schreiber, Science, 2000, 289:1760, and in further another article by S. A. Sundberg, Curr. Opin. Biotechnol., 2000, 11:47, a high-throughput screening (HTS) system using a microarray chip can be classified into a deoxyribonucleic acid (DNA) array, a small molecule array, a protein array, and a cell-based array according to a target material. A protein chip is one representative microarray-based HTS, and is illustrated in FIG. 13. A protein chip is usually manufactured by spotting a protein on a glass plate. The surface of the glass plate is activated by an aldehyde, and a protein is fixated on the surface of the chip via covalent bonding. The fixed protein maintains the same binding activity as other proteins or small molecules in a solution. G. MacBeath and S. L. Schreiber reported in Science (2000, 289:1760) that such a protein chip was used to distinguish reciprocal reactions between proteins or between proteins and small molecules, and analyze characteristics of protein kinase.

As illustrated in FIG. 14, the ELISA method includes fixating a standard ligand on a solid state plate, adding a hydrophilic material or protein so as to bind to the standard ligand bind, adding a secondary antibody of the hydrophilic material or protein so as to bind to the standard ligand, and measuring an amount of the hydrophilic material or protein bound to the secondary antibody. The secondary antibody is an enzyme-conjugated antibody such as alkaline phosphatase or peroxidase showing a specific color reaction due to a specific characteristic added in this type of antibody. However, this ELISA method may be complex due to the use of the secondary antibody, less accurate and sensitive to a target material, and take long to screen many target materials.

Therefore, there is a high demand of developing a method that allows simple and economical high-throughput screening of compounds or biological molecules without being encoded with a fluorescent material or toxic inorganic dye.

### DISCLOSURE

### Technical Problem

It is, therefore, an object of the present invention to provide a high-throughput screening method allowing fast and economical screening of numerous compounds or biological molecules.

### Technical Solution

According to various embodiments of the present invention, a method for screening a biological molecule using dielectrophoresis and microbeads encoded with silver nanoparticles and a chemical compound with strong affinity to the silver nanoparticles is introduced. Based on this introduced method, unknown biological molecules can be identified and analyzed economically and rapidly with high-throughput.

In accordance with one aspect of the present invention, there is provided a method for screening a biological molecule with high-throughput, the method including: encoding silver nanoparticles and a chemical compound on microbeads, the chemical compound having strong affinity to the silver nanoparticles; introducing a ligand specific to the biological molecule onto surface regions of the encoded microbeads; introducing the biological molecule to the microbeads including the ligand; identifying the microbeads binding to the biological molecule using dielectrophoresis; and analyzing the identified biological molecule using surface-enhanced Raman spectroscopy.

### Advantageous Effects

Various embodiments of the present invention are directed to provide a method for screening a biological molecule using dielectrophoresis and microbeads encoded with silver nanoparticles and a specific chemical compound. The screening method according to specific embodiments of the present invention does not use a fluorescent material or dying agent, which is typically used in the conventional method. Thus, as compared with the conventional screening method, the screening method according to the specific embodiments of the present invention uses a non-toxic material and is economical. Also, the screening method allows easy identification and analysis of many target materials at the same time. Therefore, a newly introduced leading compound can be easily screened using this screening method. Accordingly, this screening method can be implemented for effective and economical establishment of a system for developing pharmaceutical products.

### DESCRIPTION OF DRAWINGS

The above and other features of the present invention will become apparent from the following description of the preferred embodiments given in conjunction with the accompanying drawings, in which:

FIG. 1 is a simplified diagram illustrating a high-throughput screening method in accordance with an embodiment of the present invention;

FIG. 2 illustrates a field emission scanning electron microscopic (FESEM) view of microbeads including a carboxylic acid group in accordance with an embodiment of the present invention;

FIG. 3 illustrates FESEM views of a microbead including silver nanoparticles in accordance with an embodiment of the present invention;

FIG. 4 illustrates a micrograph of energy dispersive X-ray (EDX) spectrum of the microbead including the silver nanoparticles in accordance with the embodiment of the present invention;

FIG. 5 illustrates graphs of surface-enhanced Raman scattering (SERS) spectroscopic analysis on microbeads including silver nanoparticles and various chemical compounds in accordance with the embodiment of the present invention, wherein (A) illustrates the result when the chemical compound includes 2-mercaptotoluene; (B) illustrates the result when the chemical compound includes 2-mercaptotolune; and (c) illustrates the result when the chemical compound includes 4-mercaptopyridine;

FIG. 6 illustrates graphs of SERS spectroscopic analysis on microbeads including silver nanoparticles and various chemical compounds in accordance with an embodiment of the present invention, wherein (A) illustrates spectra of the microbeads when different chemical compounds are used for each case; and (B) illustrates encoding patterns of the microbeads;

FIG. 7 illustrates graphs of SERS spectroscopic analysis on microbeads associated with biotin-streptavidin complexes in accordance with an embodiment of the present invention, wherein (A) illustrates a graph of the microbeads without the biotin-streptavidin complexes; and (B) illustrates a graph of the microbeads with the biotin-streptavidin complexes;

FIG. 8 illustrates a micrograph of microbeads including protein G after being applied with positive dielectrophoresis at approximately 2 KHz in accordance with an embodiment of the present invention;

FIG. 9 illustrates a micrograph of microbeads including protein G after being applied with negative dielectrophoresis at approximately 20 KHz in accordance with an embodiment of the present invention;

FIG. 10 illustrates a graph for describing characteristics of dielectrophoresis applied to microbeads including protein G in accordance with an embodiment of the present invention;

FIG. 11 is a diagram illustrating a conventional optic fiber microbead array;

FIG. 12 is a diagram to describe color screening according to a conventional quantum dot-encoded bead assay;

FIG. 13 illustrates a simplified view of a protein chip used in a conventional microarray-based HTS system; and

FIG. 14 is a diagram to illustrate a procedure of fixating a standard ligand to a solid plate and leading the standard ligand to bind to a hydrophilic material or protein according to a conventional ELISA method.

### BEST MODE FOR THE INVENTION

Other aspects, features and advantages of the invention will become apparent from the following description of the embodiments with reference to the accompanying drawings, which is set forth hereinafter.

According to various embodiments of the present invention, a high-throughput screening method uses microbeads encoded with silver nanoparticles and various chemical compounds having strong affinity to the silver nanoparticles to selectively identify specific biological molecules. Silver nanoparticles provide a surface-enhanced Raman scattering effect, and thus, allow easy Raman spectroscopic analysis on the microbeads. Since each chemical compound exhibits a specific Raman spectrum, the high-throughput screening method using silver nanoparticles and a specific chemical compound is advantageous of effectively analyzing a target biologic molecule. The chemical compound may include one selected from a group consisting of 2-methylbenzenethiol, 4-methylbenzenethiol, 2-naphthalenethiol, 4-methoxybenzenethiol, 3-methoxybenzenethiol, 3,4-dimethylbenzenethiol, 3,5-dimethylbenzenethiol, 2-mercaptotoluene, 4-mercaptotoluene, and 4-mercaptopyridine. However, any chemical compound that has strong affinity to silver nanoparticles can be used for this screening method. The term “chemical compound having strong affinity to silver nanoparticles” means that the chemical compound includes a thiol (—SH) group, an amine (—NH₂) group, a cyano (—CN) group, or azide (—N₃) group. Since a chemical compound including —SH group, —NH₂ group, —CN group, or —N3 group has strong affinity to silver nanoparticles, such a chemical compound can be used in manufacturing microbeads.

Also, a ligand may be introduced on the surface of microbeads encoded with silver nanoparticles and a specific chemical compound having strong affinity to the silver nanoparticles to effectively identify a target biological molecule. Any material that can specifically bind to a target biological molecule can be used as the ligand. The ligand may include one selected from a group consisting of biotin, antibodies, lectins, and peptides. For instance, biotin strongly binds to streptavidine, and thus, biotin can effectively identify streptavidine.

Prior to introducing a ligand, a spacer may be additionally introduced on the surface of the microbeads, so that a biological molecule having a large volume can easily approach to the ligand. The spacer may include one selected from a group consisting of β-alanine, ε-aminocarproic acid, and polyethylene glycol (PEG).

Afterwards, a biological molecule is added to the microbeads with the ligand based on a strong reciprocal biding force between the ligand and the biological molecule. Any known method to those skilled in the art can be used to add the biological molecule to the microbeads.

After the biological molecule binds to the microbeads with the ligand, dielectrophoresis is applied to selectively identify those microbeads each encoded with the biological molecule.

Dielectrophoresis is a phenomenon in which small particles having a specific property are attracted or repulsed within a specific range of frequency when an alternate current (AC) voltage is applied to the small particles within a flow system. Particularly, dielectrophoresis causing small particles to be attracted is called a positive dielectrophoresis (pDEP), while dielectrophoresis causing small particles to be repulsed is called a negative dielectrophoresis (nDEP). Depending on variation in electrical conductivity on the surface of the small particles, the small particles are made to gather around a protruding or indented region of an electrode of the flow system. For instance, if a certain biological molecule binds to the surface of each of the microbeads, electrical conductivity of the surface of the microbeads increases, and thus, being subjected to positive dielectrophoresis. As a result, the microbeads gather around the protruding region of the electrode. In contrast, if a biological molecule does not bind to the surface of the microbeads, electrical conductivity of the surface of the microbeads decreases, and thus, being subjected to negative dielectrophoresis. As a result, the microbeads gather around the indented region of the electrode. When the microbeads combined with the specific biological molecule flow to the electrode, an AC voltage within a specific range of frequency is applied. Each biological molecule is applied with a different range of frequency.

In an experimental embodiment of the present invention, Protein G was selected as a biological molecule to verify whether the screening method according to an embodiment of the present invention could identify a target biological molecule. Microbeads encoded with the selected protein G gathered around a protruding region of an electrode at a frequency of approximately 2 KHz, and around an indented region of the electrode at a frequency of approximately 20 KHz. Therefore, dielectrophoresis allowed identification of a specific protein.

If many target biological molecules need to be identified at the same time, microbeads are encoded with silver nanoparticles and a chemical compound, and ligands that can identify the target biological molecules are fixated on the microbeads to react with the microbeads. Afterwards, dielectrophoresis is applied. If unknown types of certain biological molecules bind to the microbeads, the microbeads to which the biological molecules bind are separated from the rest microbeads due to positive dielectrophoresis.

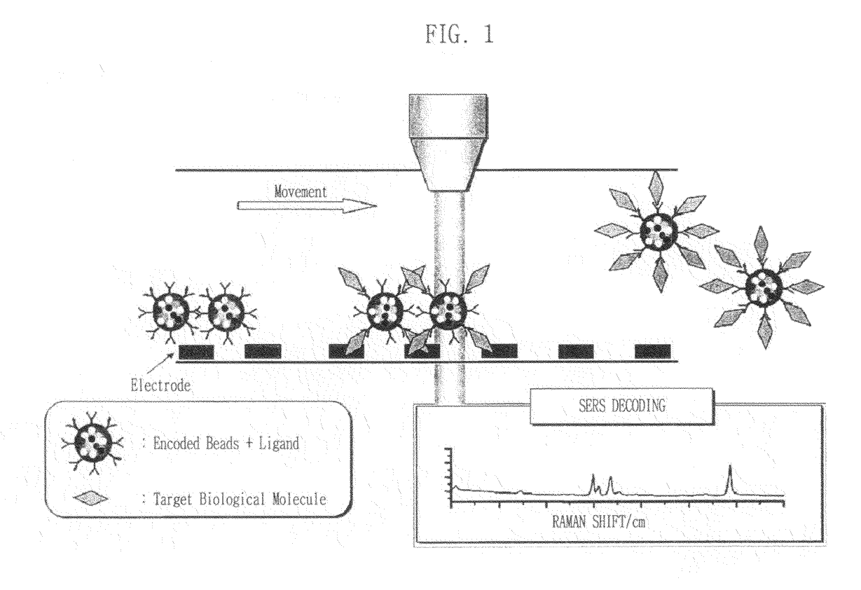

The separated microbeads are analyzed using SERS spectroscopy to identify types and characteristics of the bound biological molecules. FIG. 1 schematically illustrates this high-throughput screening method according to the embodiment of the present invention.

Target biological molecules such as proteins and deoxyribonucleic acid (DNA) can be effectively and economically identified and analyzed within a short period of time by using microbeads specific to such biological molecules and dielectrophoresis.

Hereinafter, detailed description of the above described screening method will be provided.

It should be noted that the foregoing embodiments on the high-throughput screening method are merely illustrative and should not be construed as to limit the scope and sprit of the present invention.

### Embodiment 1

### Synthesis of Encoded Microbeads by SERS

An experiment was carried out to synthesize microbeads encoded with silver nanoparticles and a chemical compound on the surface of the microbeads.

### 1-1. Synthesis of Microbeads

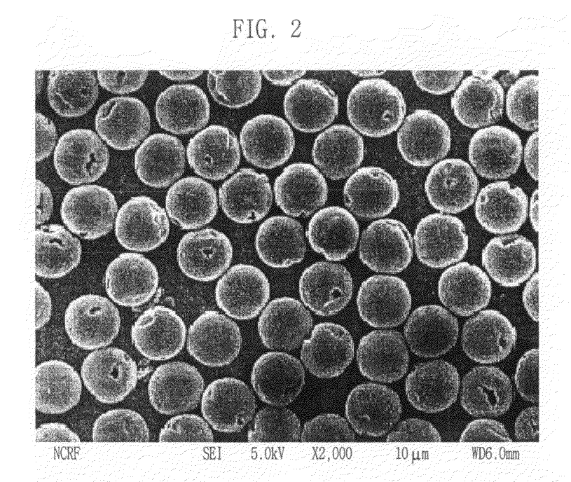

Ethanol, styrene, 2,2′-azo-bis-isobutyronitrile (AIBN) of approximately 2 weight percent, and polyvinyl pyrroridone(PVP)-40 of approximately 1.8 weight percent were reacted with each other to synthesize polystyrene (PS) seeds. Styrene, divinylbenzene, methacrylic acid, sodium dodecyl sulfate (SDS) of approximately 0.25 weight percent, and benzoyl peroxide (BPO) of approximately 2 weight percent were added to and reacted with the PS seeds at approximately 30° C. for approximately 24 hours and then at approximately 70° C. for approximately 24 hours. As a result of this reaction, carboxyl beads were obtained. FIG. 2 illustrates a micrographic view of the carboxyl microbeads.

### 1-2. Introduction of Amine Group

The carboxyl microbeads of approximately 0.3 g (more specifically 3.0 mmol/g) were made to react with ethylene diamine of approximately 10 equivalents, diisopropyl carbodiimide (DIC) of approximately 3 equivalents, 1-hydroxybenzotriazole (HOBt) of approximately 4 equivalents, and diisopropylethylamine (DIEA) of approximately 5 equivalents so as to introduce an amine group on the surface of the microbeads.

### 1-3. Synthesis of Encoded Microbeads Using Silver Nanoparticles and a Chemical Compound Based on SERS

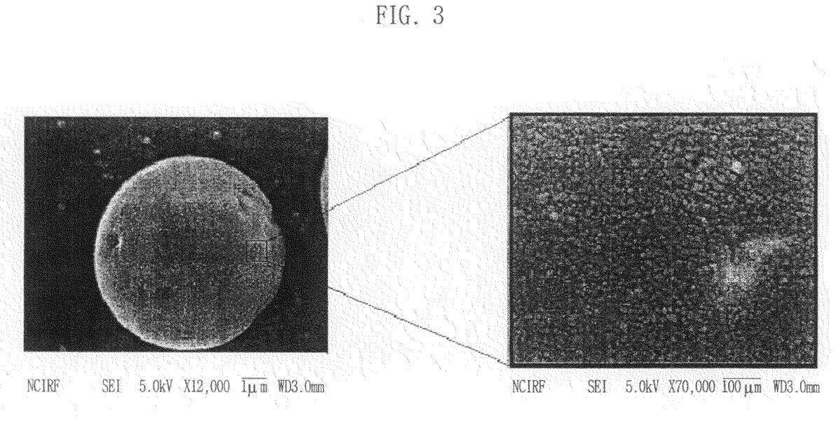

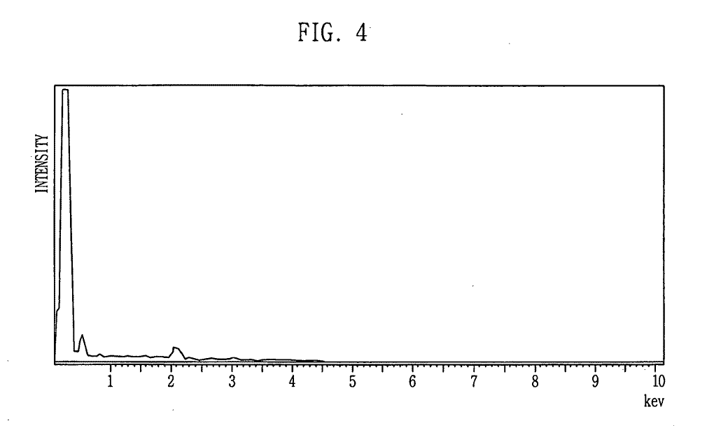

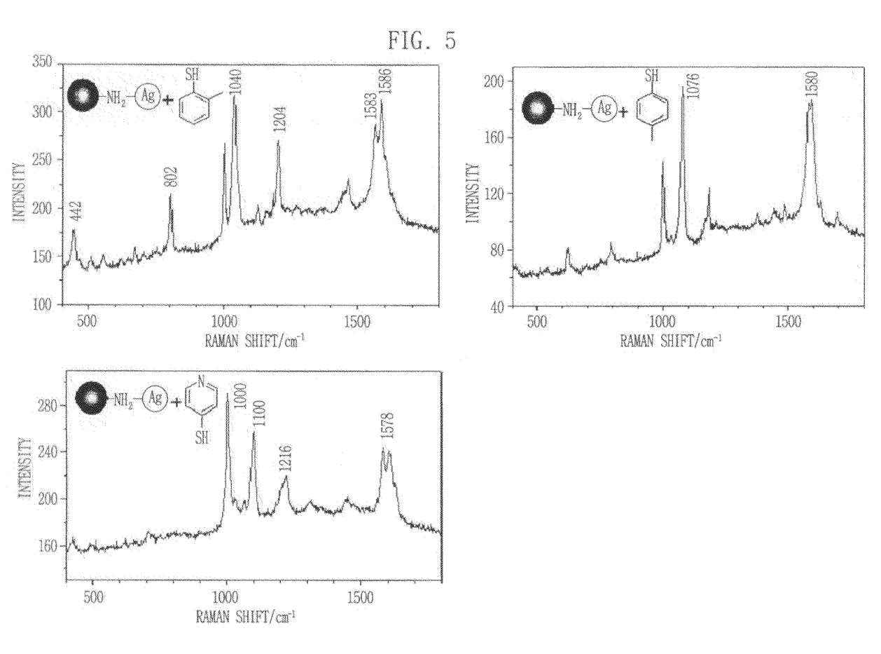

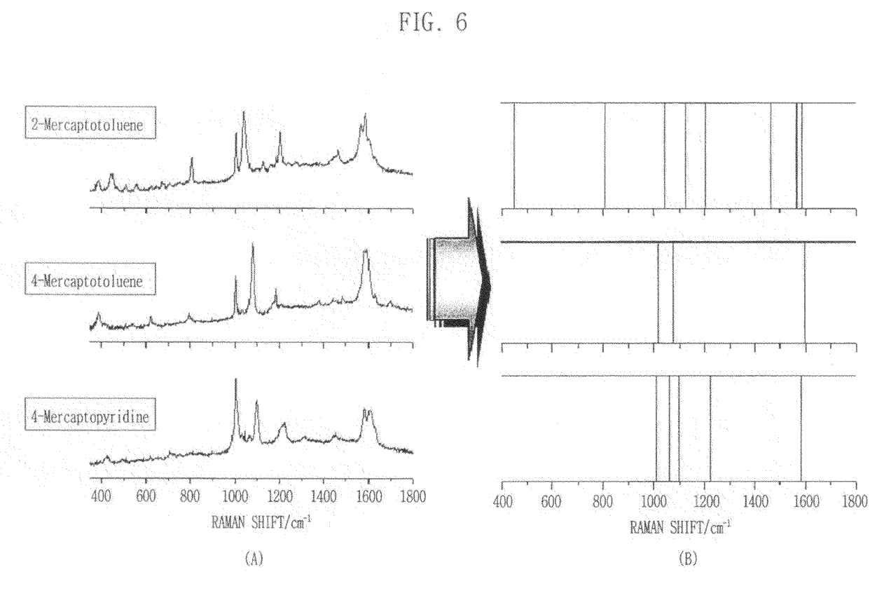

The microbeads of approximately 3.0 g (more specifically, 0.22 mmol/g) reacted with lysine of approximately 3 equivalents, DIC of approximately 3 equivalents, HOBt of approximately 4 equivalents, DIEA of approximately 3 equivalents, and dimethylformamide (DMF) to introduce lysine on the microbeads. As a result, the amine group was amplified. Silver nanoparticles were fixated to the amplified amine group, and 2-mercaptotoluene, 4-mercaptotoluene and 4-mercaptopyridine were individually introduced on the surface of the microbeads. Each of the microbeads was analyzed using electron microscopy, EDX spectroscopy, and Raman spectroscopy. FIGS. 3 to 6 illustrate the analysis results.

### Embodiment 2

### Applicability Test on Screening of Biological Molecules Using SERS Encoded Microbeads

An experiment based on formation of a biotin-streptavidin complex was carried out to verify applicability of biological molecule screening based on the microbeads fabricated according to the first experimental embodiment of the present invention.

β-alanine and ε-aminocarproic acid were introduced to the amine group of the individual microbeads, so that a target biological molecule having large volume (e.g., streptavidin) can easily approach to the microbeads fabricated according to the first experimental embodiment. Biotin having affinity to streptavidin was then fixated as a ligand.

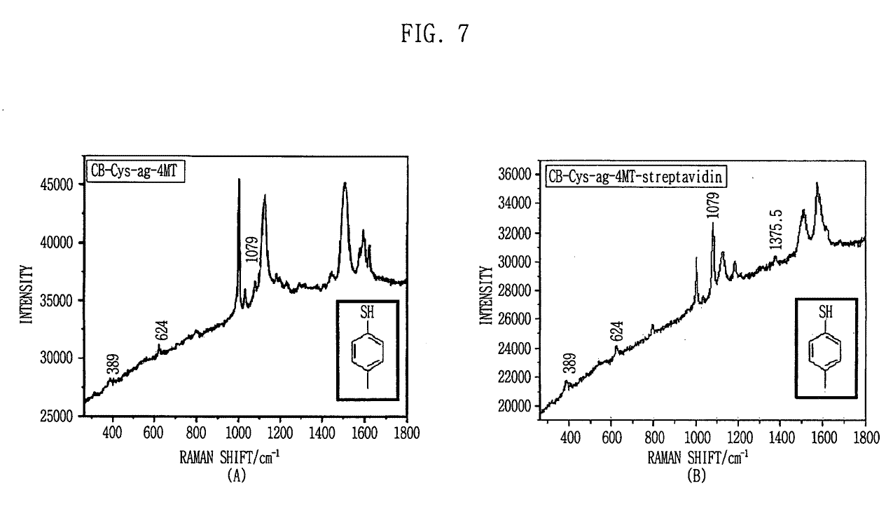

The microbeads binding to the biotin reacted with the streptavidin, and the resultant product was analyzed using Raman spectroscopy. FIG. 7 illustrates the analysis results.

As illustrated in FIG. 7, the microbeads without the biotin-streptavidin complexes and the microbeads with the biotin-streptavidin complexes show the same Raman spectra indicating that SERS encoding is stable enough to maintain its Raman signal during the assay and can identify the kind of target biological molecule after the assay. In other words, the microbeads can be applied to screen a specific biological molecule.

### Embodiment 3

### Identification and Analysis on Protein G Using Microbeads and Dielectrophoresis

An experiment for identifying and analyzing protein G using the microbeads fabricated according to the first experimental embodiment and dielectrophoresis was carried out.

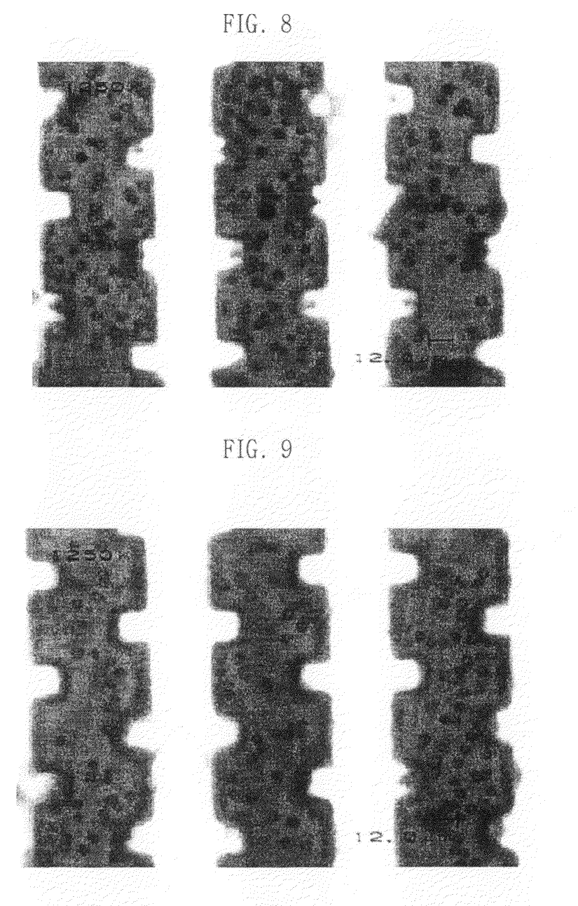

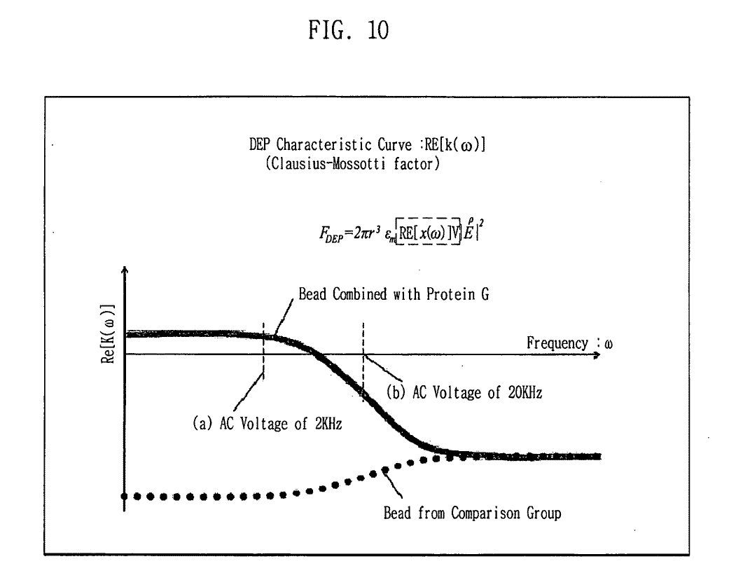

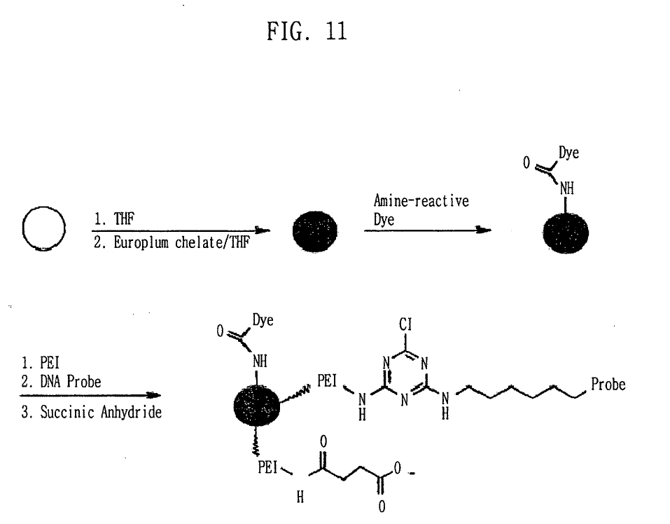

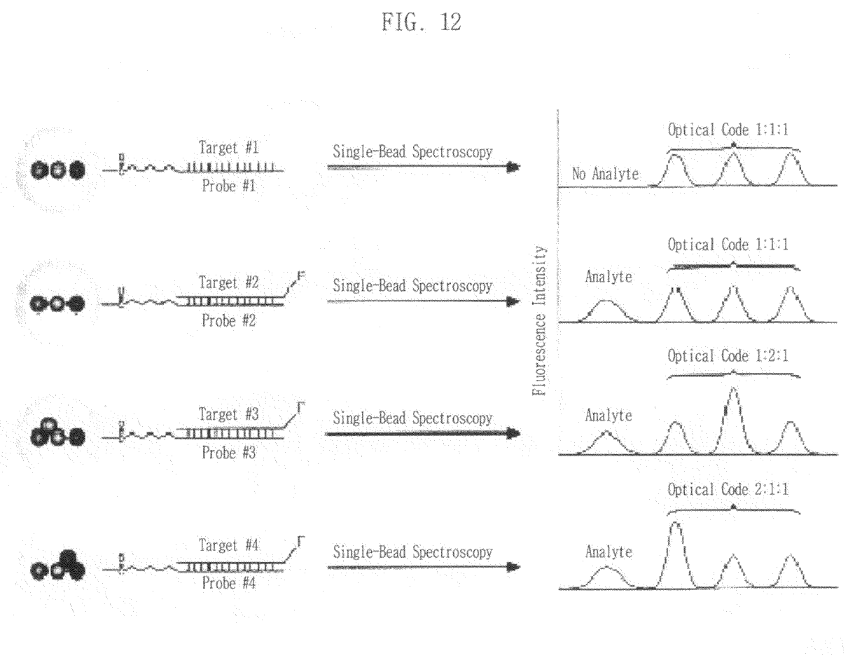

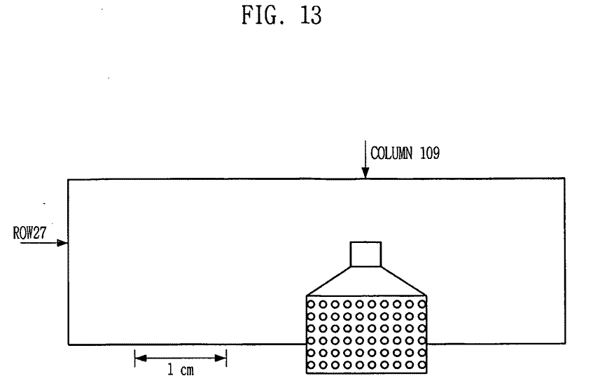

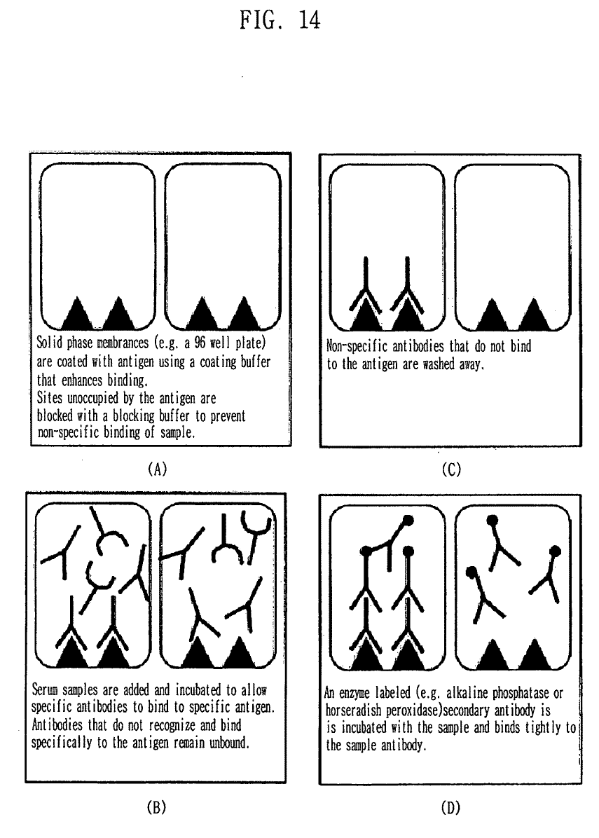

β-alanine and ε-aminocarproic acid were introduced into the amine group existing on the surface of each of the microbeads so as for protein G to easily approach to the microbeads fabricated according to the first experimental embodiment. The microbeads with the protein G were put into a flow system, and subjected to dielectrophoresis. The microbeads were exerted with different forces at approximately 2 KHz and at approximately 20 KHz. These results were illustrated in FIGS. 8 and 9. Particularly, FIG. 10 is a graph illustrating dielectrophoresis (DEP) characteristics exhibited differently in a test group of the microbeads with the protein G and a comparison group of microbeads prepared differently from those of the test group.

As illustrated in FIG. 8, the microbeads gathered around a protruding region of an electrode at approximately 2 KHz. That is, positive dielectrophoresis (pDEP) took place. As illustrated in FIG. 9, the microbeads gathered around an indented region of the electrode at approximately 20 KHz. That is, negative dielectrophoresis (nDEP) took place. The microbeads around the protruding region of the electrode bound to target biological molecules, while the microbeads around the indented region of the electrode did not bind to the target biological molecules.

After the microbeads around the protruding region of the electrode were collected, and analyzed using SERS spectroscopy. The analysis result verified whether the target biological molecule is protein G or not by analyzing SERS spectra denoting the kind of target biological molecule.

While the present invention has been described with respect to certain preferred embodiments, it will be apparent to those skilled in the art that various changes and modifications may be made without departing from the scope of the invention as defined in the following claims.

What is claimed is:

1. A method for screening a biological molecule with high-throughput, comprising:
encoding silver nanoparticles and a chemical compound on microbeads, the chemical compound having strong affinity to the silver nanoparticles;
introducing a ligand specific to the biological molecule onto surface regions of the encoded microbeads;
introducing the biological molecule to the microbeads including the ligand;
identifying the microbeads binding to the biological molecule using dielectrophoresis; and
analyzing the identified biological molecule using surface-enhanced Raman scattering spectroscopy.

2. The method of claim 1, wherein the chemical compound having strong affinity to the silver nanoparticles includes one selected from a group consisting of 2-methylbenzenethiol, 4-methylbenzenethiol, 2-naphthalenethiol, 4-methoxybenzenethiol, 3-methoxybenzenethiol, 3,4-dimethylbenzenethiol, 3,5-dimethylbenzenethiol, 2-mercaptotoluene, 4-mercaptotoluene, and 4-mercaptopyridine.

3. The method of claim 1, wherein the ligand includes one selected from a group consisting of biotin, antibodies, lectins, and peptides.

4. The method of claim 1, wherein the biological molecule includes one of proteins and DNA (deoxyribonucleic acid).

5. The method of claim 1, further comprising, prior to introducing the ligand, introducing a spacer on the surface regions of the encoded microbeads.

6. The method of claim 5, wherein the spacer includes one selected from a group consisting of β-alanine, ε-aminocarproic acid, and polyethylene glycol.
